(19) United States
(12) Patent Application Publication
(10) Pub. No.: US 2020/0092034 A1
(43) Pub. Date: Mar. 19, 2020

(54) SYSTEMS AND METHODS FOR MANAGING A CONTROL CHANNEL IN A COMMUNICATION NETWORK

(71) Applicant: CABLE TELEVISION LABORATORIES, INC., Louisville, CO (US)

(72) Inventor: Douglas D. Jones, Boulder, CO (US)

(21) Appl. No.: 16/575,208

(22) Filed: Sep. 18, 2019

Related U.S. Application Data
(60) Provisional application No. 62/732,888, filed on Sep. 18, 2018.

(51) Int. Cl. H04L 1/00; H04L 12/28; H04L 5/00

(52) U.S. Cl. CPC H04L 1/0009; H04L 1/0003; H04L 5/0007; H04L 12/2801

(57) ABSTRACT

A method for managing a control channel in a communication network includes (1) receiving, at a control subsystem, first status information from a network device, (2) comparing, at the control subsystem, the first status information to a first threshold condition, and (3) in response to the first status information meeting the first threshold condition, causing a first control channel in the communication network to move from a first location in radio-frequency spectrum to a second location in radio-frequency spectrum. Another method for managing a control channel in a communication network includes (1) receiving, at a control subsystem, a first signal from a network device, and (2) in response to receiving the first signal, causing a first control channel in the communication network to move from a first location in radio-frequency spectrum to a second location in radio-frequency spectrum.

### RELATED APPLICATIONS

This application claims benefit of priority to U.S. Provisional Patent Application Ser. No. 62/732,888, filed on Sep. 18, 2018, which is incorporated herein by reference.

### BACKGROUND

Communication networks commonly include one or more control channels along with data channels. For example, a cable communication network operating according to a Data Over Cable Services Interface Specification (DOCSIS) includes at least one control channel in the form of a Physical Link Channel (PLC), and a wireless communication network operating according to a fourth-generation (4G) wireless communication protocol or a fifth-generation (5G) wireless communication protocol includes at least one control channel in the form of a Physical Broadcast Channel (PBCH).

Control channels are typically essential to communication network operation. For example, a cable modem needs a PLC to obtain control information that the modem requires to operate in a cable communication network. Examples of possible control information carried by a PLC include, but are not limited to, low-density parity check (LDPC) order, quadrature amplitude modulation (QAM) order, and interleaver depth. Additionally, user equipment (UE) in a 4G or 5G wireless communication network needs a PBCH to provide control information that the UE requires to operate in the wireless communication network. Examples of possible control information carried by a PBCH include, but are not limited to, a Master Information Block (MIB). A MIB may specify, in part, one or more of system bandwidth, Physical Hybrid-ARQ Indicator Channel (PHICH) information, system frame number, and number of transmit antennas used by a wireless base station.

### BRIEF DESCRIPTION OF THE DRAWINGS

FIG. 1 is a schematic diagram illustrating a communication network configured to automatically manage a control channel, according to an embodiment.

FIG. 2 is a flow chart illustrating a method for automatically managing a control channel in a communication network, according to an embodiment.

FIG. 3 is a schematic diagram illustrating one example of a control channel being relocated in radio-frequency spectrum, according to an embodiment.

FIG. 4 is a schematic diagram illustrating one example of contents of a database including identities of possibly-interfering radio signals, according to an embodiment.

FIG. 5 is a flow chart illustrating another method for automatically managing a control channel in a communication network, according to an embodiment.

FIG. 6 is a schematic diagram illustrating a communication network including two control channels, according to an embodiment.

FIG. 7 is a flow chart illustrating another method for automatically managing a control channel in a communication network, according to an embodiment.

FIG. 8 is a schematic diagram illustrating a communication network including a control channel translation device, according to an embodiment.

FIGS. 9-11 are schematic diagrams illustrating operating examples of the control channel translation device of FIG. 8.

FIG. 12 is a schematic diagram illustrating a communication network including a plurality of branches and configured to automatically manage a control channel.

FIG. 13 is a schematic diagram illustrating a cable communication network configured to automatically manage control channels, according to an embodiment.

FIG. 14 is a schematic diagram illustrating another cable communication network configured to automatically manage control channels, according to an embodiment.

FIG. 15 is a flow chart illustrating another method for automatically managing a control channel in a communication network, according to an embodiment.

### DETAILED DESCRIPTION OF THE EMBODIMENTS

Control channels are typically transmitted using a robust modulation scheme to promote control channel reliability. For example, a PLC in a cable communication network is normally modulated at a relatively low order, e.g. according to a 16-bit quadrature amplitude modulation (QAM) scheme, to promote reliable PLC decoding. Nevertheless, interference on a control channel may prevent a network device, such as a modem, from decoding the control channel. For example, a long-term evolution (LTE) wireless communication channel, which is typically 20 megahertz (MHz) wide, may ingress a cable communication network, such as due to a damaged electrical cable or a loose electrical connection. The LTE wireless communication channel may overlap with a PLC of the cable communication network, potentially inhibiting one or more cable modems from decoding the PLC. Consequently, the affected cable modems will be unable to use a communication channel associated with the PLC. As another example, unintended egress from a cable communication network may prevent UE on a wireless communication network from decoding a PBCH.

Disclosed herein are systems and methods for automatically managing a control channel in a communication network, which may at least partially overcome one or more of the problems discussed above. In certain embodiments, a control subsystem in a communication network automatically causes a control channel to move from a first location in radio-frequency spectrum to a second location in radio-frequency spectrum, such as in response to actual or anticipated interference with the control channel at the first location in radio-frequency spectrum. In some embodiments, the control subsystem automatically moves the control channel to a location in radio-frequency spectrum that is relatively-free, or completely-free, of radio-frequency signals that may interfere with the control channel. Accordingly, the disclosed systems and methods promote reliable decoding of a control channel in environments with dynamic interference, by automatically relocating the control channel in radio-frequency spectrum to help prevent interference with the control channel. Possible applications of the disclosed systems and methods include, but are not limited to, communication systems including one or more orthogonal frequency-division multiplexing (OFDM) communication channels, orthogonal frequency-division multiple access (OFDMA) communication channels, etc.

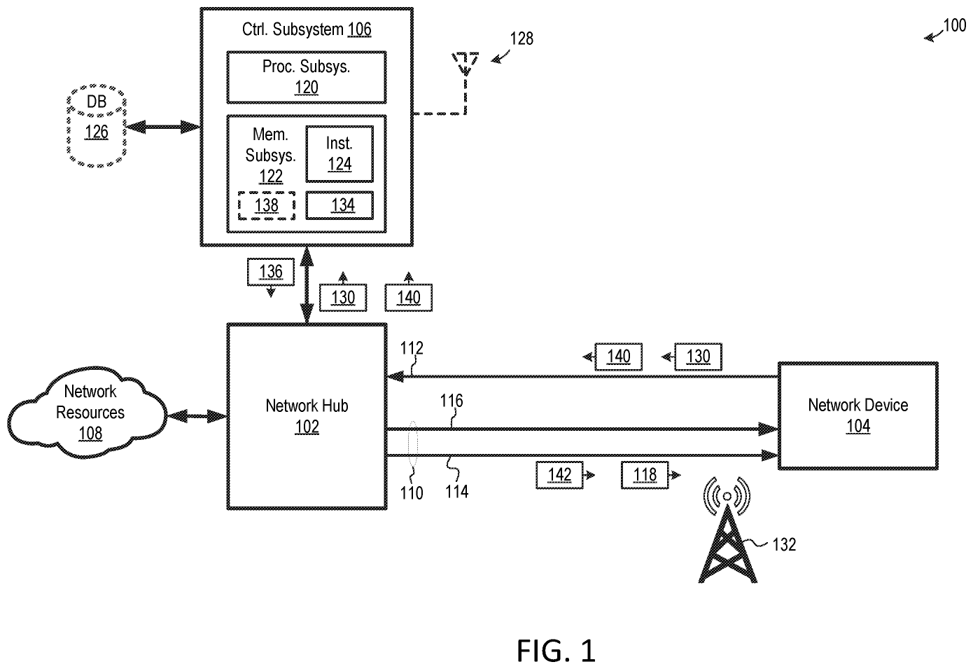

FIG. 1 is a schematic diagram illustrating a communication network 100 configured to automatically manage a control channel. Communication network 100 includes a network hub 102, a network device 104, and a control subsystem 106. Although FIG. 1 only includes a single network device 104 for illustrative simplicity, communication network 100 may (and often will) include a plurality of network devices.

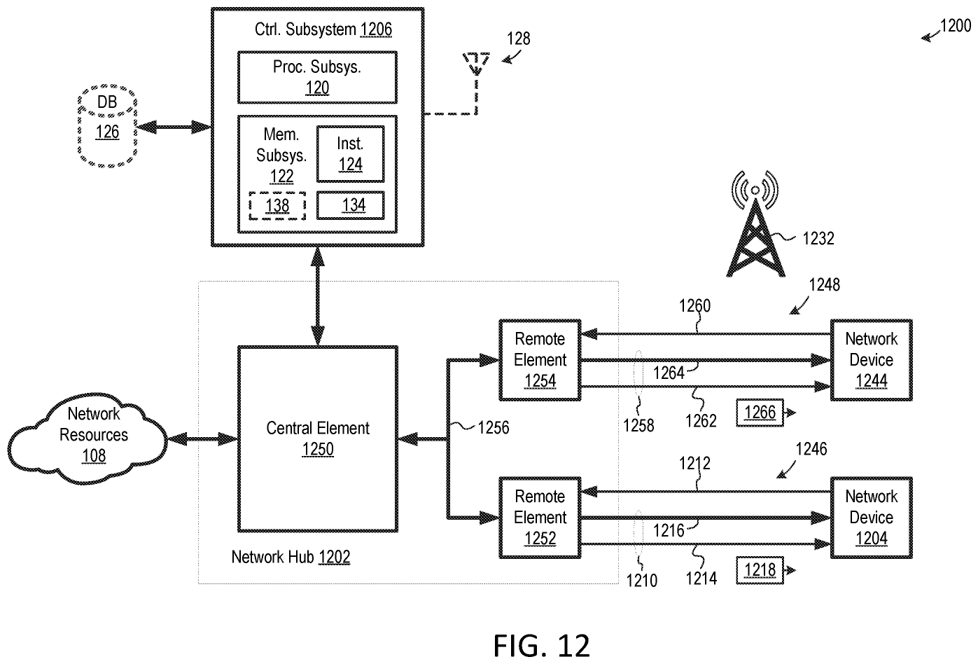

Network hub 102 is configured to interface network devices, such as network device 104, with network resources 108. Examples of network resources 108 include, but are not limited to, the public Internet, voice communication applications, conferencing applications, and/or content delivery applications. In some embodiments, network resources 108 are part of another network, such as a core communication network. In particular embodiments, network hub 102 includes a wireless or wired relay node, an Ethernet switch, a cable modem termination system (CMTS), an optical line terminal (OLT), a wireless communication termination system (e.g. a packet core or an evolved packet core), a wireless relay system, or a digital subscriber line access multiplexer (DSLAM). Although network hub 102 is depicted as a single element, in some embodiments, network hub 102 includes a plurality of elements, such as a central element and one or more remote elements, such as discussed below with respect to FIG. 12. For example, in some embodiments network hub 102 includes a CMTS and one or more fiber nodes, and in some other embodiments, network hub 102 includes a wireless communication network core and one or more wireless base stations. Accordingly, network hub 102 could include elements in a plurality of different locations.

In certain embodiments, network device 104 includes a modem, such as a cable modem, a digital subscriber line (DSL) modem, an optical network terminal (ONT), or an optical network unit (ONU). In embodiments where network device 104 includes a cable modem, the cable modem optionally operates according to a DOCSIS communication protocol. In embodiments where network device includes an ONT or an ONU, the ONT or ONU optionally operates according to an ethernet passive optical network (EPON) communication protocol, a radio frequency over glass (RFOG) communication protocol, or a gigabit passive optical network (GPON) communication protocol. In some embodiments, network device 104 includes user equipment, such as a mobile telephone, a computer, a set-top device, a data storage device, an Internet of Things (IoT) device, an entertainment device, a computer networking device, a smartwatch, a wearable device with wireless capability, a medical device, etc. In certain embodiments, network device 104 includes a wireless access device (including, for example, eNBs, gNBs, and IAB access point, microcell, picocell, femtocell, macrocell, Wi-Fi Aps, etc). However, network device 104 can take other forms without departing from the scope hereof.

Each network device is communicatively coupled to network hub 102 via one or more wired and/or wireless communication channels. For example, network device 104 is communicatively coupled to network hub 102 via a downlink communication channel 110 and an uplink communication channel 112. Network device 104 may be communicatively coupled to network hub 102 via additional communication channels without departing from the scope hereof. In some embodiments, downlink communication channel 110 and uplink communication channel 112 include optical cable, electrical cable (e.g. coaxial electrical cable and/or twisted-pair electrical cable), and/or a wireless communication link. In certain embodiments, downlink communication channel 110 and uplink communication channel 112 share one or more common communication mediums. For example, in particular embodiments, communication network 100 operates at least partially according to a DOCSIS communication protocol, and downlink communication channel 110 and uplink communication channel 112 share a combination of optical cable and coaxial electrical cable, sometimes referred to as hybrid-fiber-coax (HFC). As another example, in some embodiments, communication network 100 operates at least partially according to a wireless communication protocol (e.g. a 4G wireless communication protocol or a 5G communication protocol), and each of downlink communication channel 110 and uplink communication channel 112 includes a wireless communication link.

Downlink communication channel 110 includes a control channel 114 and a data channel 116. In some embodiments, downlink communication channel 110 is an OFDM communication channel. Control channel 114 carries control information 118 to network device 104. Network device 104 optionally uses control information 118 to establish and/or maintain communication channels with network hub 102. Some possible examples of control information 118 include, but are not limited to, modulation scheme information, error-correction information, communication channel bandwidth information, and/or communication channel frequency information. In some embodiments where communication system 100 operates at least partially according to a DOCSIS communication protocol, control channel 114 includes a PLC. In certain embodiments where communication system 100 operates according to a 4G or 5G wireless communication protocol, control channel 114 includes a PBCH. Data channel 116 carries data from network hub 102 to network device 104.

Uplink communication channel 112 carries information from network device 104 to network hub 102. In some embodiments, uplink communication channel 112 includes a control channel (not shown) and a data channel (not shown).

Control subsystem 106 is configured to control location of control channel 114 in radio frequency spectrum. In some embodiments, control subsystem 106 is separate from network hub 102. For example, in particular embodiments, control subsystem 106 is located close to network hub 102, while in some other embodiments, control subsystem 106 is located remote from network hub 102, such as in one or more remote data centers. In certain other embodiments, control subsystem 106 is partially or fully integrated with network hub 102, and in these embodiments, control subsystem 106 may share one or more components with network hub 102.

Control subsystem 106 includes a processing subsystem 120 and a memory subsystem 122. Processing subsystem 120 includes one or more processors configured to execute instructions 124 stored in memory subsystem 122 to perform functions of control subsystem 106. Instructions 124 are, for example, software and/or firmware. Although processing subsystem 120 and memory subsystem 122 are each illustrated as being single devices, one or more of processing subsystem 120 and memory subsystem 122 can include multiple constituent components, which do not necessarily need to be located at a common location. For example, processing subsystem 120 and memory subsystem 122 may be implemented by a distributed computing system including a plurality of constituent components at different locations. Control subsystem 106 is optionally communicatively coupled to one or more of a database 126 and an antenna 128. In some embodiments, one or more of database 126 and antenna 128 are integrated within control sub system 106.

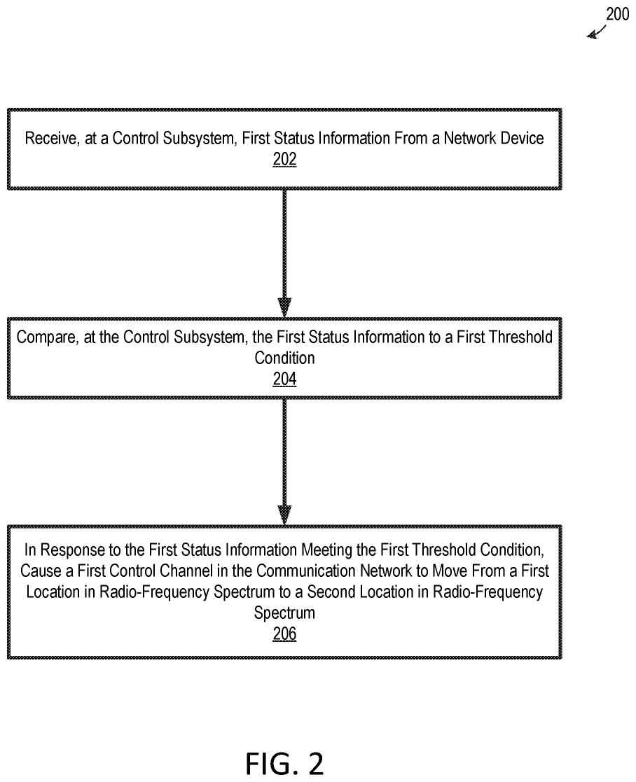

Processing subsystem 120 is configured to execute instructions 124 to cause control channel 114 to be automatically relocated in radio-frequency spectrum, to help prevent interference with control channel 114. For example, in one embodiment, processing subsystem 120 is configured to execute instructions 124 to perform a method 200 for automatically managing a control channel in a communication network, as illustrated in the FIG. 2. In a block 202 of method 200, control subsystem 106 receives status information 130 from network device 104. In some embodiments, such as illustrated in FIG. 1, control subsystem 106 receives status information 130 via network hub 102, i.e., network device 104 transmits status information 130 to network hub 102, and network hub 102 forwards status information 130 to control subsystem 106. In some other embodiments, control subsystem 106 receives status information 130 in another manner, such as directly from network device 104. In certain embodiments, network device 104 periodically provides status information 130 to network hub 102 and/or control subsystem 106, while in some other embodiments, network device 104 provides status information 130 in response to a request for status information, such as in response to a request from network hub 120 or a request from control subsystem 106. For example, in certain embodiments where communication network 100 operates at least partially according to a DOCSIS communication protocol, network device 104 provides status information 130 in response to a proactive network maintenance (PNM) query from network hub 102 and/or from control subsystem 106.

Status information 130 represents one or more operating conditions of network device 104, and control subsystem 106 is configured to use status information 130 to determine if control channel 114 should be relocated in radio-frequency spectrum, such as due to interference from an interfering signal source 132. For example, in some embodiments, status information 130 includes modulation error information of one or more components of control channel 114. In certain embodiments where communication network 100 operates at least partially according to a DOCSIS communication protocol and downlink communication channel 110 is an OFDM communication channel, status information 130 optionally includes a Received Modulation Error Ratio (RxMER) of every subcarrier of downlink communication channel 110. As another example, in some embodiments, status information 130 includes signal-to-noise-ratio (SNR) of control information 118 arriving at network device 104.

Although interfering signal source 132 is depicted in FIG. 1 as a wireless base station, interfering signal source 132 could take a different form without departing from the scope hereof. Interfering signal source 132 is not necessarily part of communication network 100.

In a block 204 of method 200, control subsystem 106 compares status information 130 to a threshold condition 134. Threshold condition 134 corresponds to a state of status information 130 that triggers control subsystem 106 to cause control channel 114 to be relocated in radio-frequency spectrum. For example, in one embodiment, (a) status information 130 includes modulation error information of one or more components of control channel 114, and (b) threshold condition 134 corresponds to a modulation error value that triggers control subsystem 106 to cause control channel 114 to be relocated in radio-frequency spectrum. In this embodiment, status information 130 meets threshold condition 134 if modulation error is greater than or equal to the modulation error value of threshold value 134. As another example, in another embodiment, (a) status information 130 includes SNR of control information 118 arriving at network device 104, and (b) threshold condition 134 corresponds to a SNR value that triggers control subsystem 106 to cause control channel 114 to be relocated in radio-frequency spectrum. In this embodiment, status information 130 meets threshold condition 134 if SNR is less than or equal to the SNR value of threshold value 134.

In a block 206 of method 200, control subsystem 106 causes control channel 114 to move from a first location in radio-frequency spectrum to a second location in radio-frequency spectrum, in response to status information 130 meeting threshold condition 134. For example, in an embodiment, control subsystem 106 generates a relocate control channel command 136 in response to modulation error being greater than or equal to a modulation error value of threshold value 134. As another example, in an embodiment, control subsystem 106 generates relocate control channel command 136 in response to SNR being less than or equal to a SNR value of threshold value 134. Network hub 102 moves control channel 114 from the first location in radio-frequency spectrum to the second location in radio-frequency spectrum, in response to receiving relocate control channel command 136 from control subsystem 106.

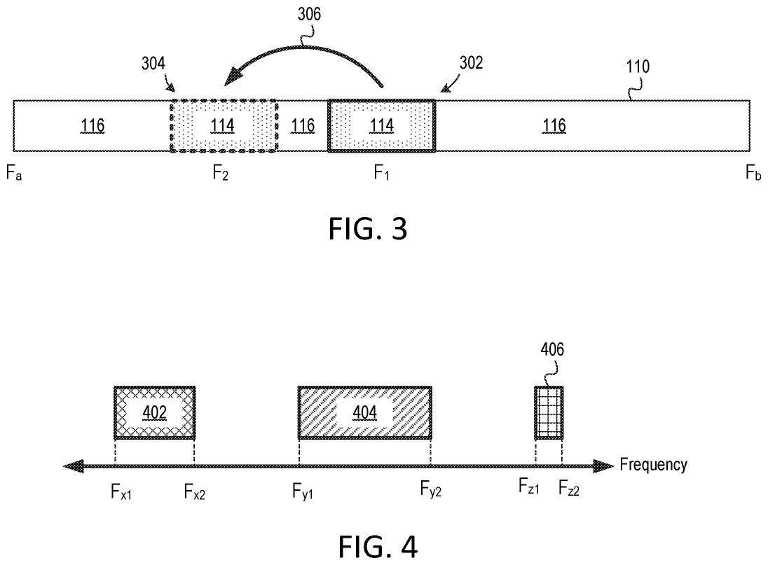

FIG. 3 is a schematic diagram illustrating one example of control channel 114 being relocated in radio-frequency spectrum. In this example, downlink communication channel 110 ranges from frequency Fₐ to frequency F_{b} in radio-frequency spectrum. Control channel 114 is initially located at a first location 302 in radio-frequency spectrum having a center frequency F₁, and the portion of downlink communication channel 110 that is not occupied by control channel 114 is allocated to data channel 116. Network hub 102 moves, as indicated by an arrow 306, control channel 114 from first location 302 to a second location 304 in radio-frequency spectrum having a center frequency F₂, in response to receiving relocate control channel command 136 from control subsystem 106. In some embodiments, such as illustrated in FIG. 3, second location 304 is lower in frequency than first location 302, to help increase reliability of control channel 114 decoding, because attenuation of control channel 114 typically decreases with decreasing frequency of control channel 114. Although the example of FIG. 3 illustrates downlink communication channel 110 as occupying a block of contiguous radio-frequency spectrum, downlink communication channel 110 could alternately occupy a plurality of separate blocks of radio frequency spectrum. In this alternate embodiment, control channel 114 optionally spans two or more of the plurality of separate blocks of radio frequency spectrum.

In some embodiments, the second location in radio-frequency spectrum is predetermined or is randomly determined. In some other embodiments, processing subsystem 120 executes instructions 124 to determine the second location in radio-frequency spectrum, e.g. location 304 of FIG. 3, such that the second location is relatively-free, or completely-free, of radio-frequency signals that may interfere with control channel 114. For example, in some embodiments, (a) database 126 (FIG. 1) includes a list of known radio-frequency spectrum in use at communication network 100 that might interfere with control channel 114, and (b) control subsystem 106 determines the second location in radio-frequency spectrum in a manner that prevents, or minimizes, overlap in frequency of the second location with the radio-frequency spectrum listed in database 126. For example, FIG. 4 is a schematic diagram illustrating one example of contents of database 126. In this example, database 126 includes radio-frequency spectrum 402, 404 and 406, which is in use at communication system 100. Radio-frequency spectrum 402, 404, and 406 range from frequencies Fₓ₁ to Fₓ₂, F_{y1} to F_{y2}, and F_{z1} to F_{z2}, respectively. Possible examples of use of radio-frequency spectrum 402, 404, and 406 include, but are not limited to, cellular telephone radio spectrum, air traffic control radio spectrum, amateur radio spectrum, Multimedia over Coax Alliance (MoCA) radio spectrum, and/or military radio spectrum. Signals in radio-frequency spectrum 402, 404, and 406 may interfere with control channel 114, and control subsystem 106 therefore determines the second location in radio-frequency spectrum, e.g. location 304 of FIG. 3, in a manner which minimizes, or eliminates, overlap in frequency of the second location with radio-frequency spectrum 402, 404, and 406. In other words, control subsystem 106 determines the second location in radio-frequency spectrum such that the frequency spanned by the second location, e.g. spectrum at location 304 of FIG. 3, does not overlap, or minimally overlaps, the frequency spanned by radio-frequency spectrum 402, 404, and 406.

In some embodiments, database 126 is manually generated, such as by an operator consulting published sources identifying radio-frequency spectrum in use at communication network 100, and/or by an operator using their knowledge of radio-frequency spectrum in use at communication network 100. In some embodiments, memory subsystem 122 further includes database instructions 138, and processing subsystem 120 executes database instructions 138 to automatically generate database 126. For example, in some embodiments, processing subsystem 120 executes database instructions 138 to automatically (a) obtain, from an electronic source such as the Internet, identities of possibly-interfering radio-frequency spectrum that is in-use at communication network 100, and (b) write the identities of the possible interfering radio-frequency spectrum in database 126. As another example, in some embodiments, processing subsystem 120 executes database instructions 138 to automatically (a) causes antenna 128 to sample radio-frequency spectrum at communication system 100 to identify possibly-interfering radio-frequency signals that are in-use at communication network 100, and (b) write in database 126 identities of radio-frequency spectrum corresponding to the possible interfering radio-frequency signals. As another example, in some embodiments, processing subsystem 120 executes database instructions 138 to automatically (a) identify radio-frequency spectrum which has previously includes signals causing interference with control channel 114, and (b) write the identities of radio-frequency spectrum in database 126.

In certain embodiments, control subsystem 106 is further configured to proactively prevent control channel 114 interference by selecting an initial location of control channel 114 in radio-frequency spectrum in a manner which reduces, or eliminates, frequency overlap of control channel 114 with possibly-interfering radio-frequency spectrum that is in-use at communication network 100. For example, in certain embodiments, processing subsystem 120 is configured to execute instructions 124 to determine an initial location of control channel 114 in radio-frequency spectrum, e.g. during configuration or provisioning of network hub 102, such that control channel 114 does not overlap in frequency with radio-frequency spectrum identified in database 126.

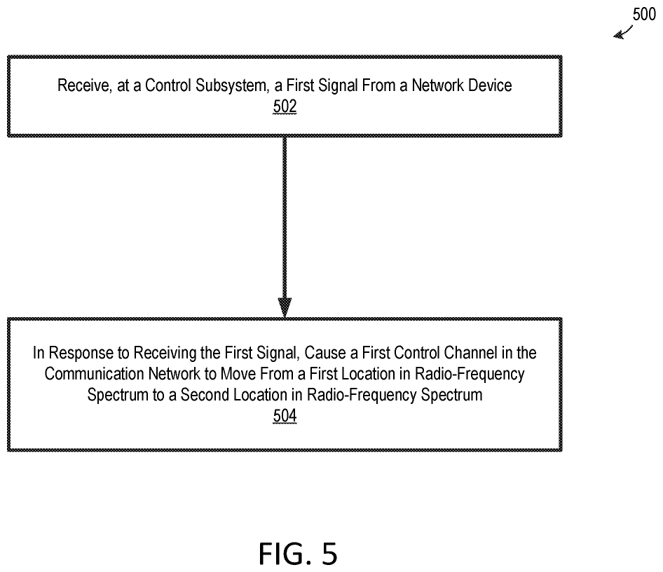

In some embodiments, processing subsystem 120 is configured to execute instructions 124 to perform a method 500 for automatically managing a control channel in a communication network, as illustrated in the FIG. 5. In a block 502 of method 500, control subsystem 106 receives a signal 140 (FIG. 1) from network device 104. In some embodiments, such as illustrated in FIG. 1, control subsystem 106 receives signal 140 via network hub 102, i.e., network device 104 transmits signal 140 to network hub 102, and network hub 102 forwards signal 140 to control subsystem 106. In some other embodiments, control subsystem 106 receives signal 140 in another manner, such as directly from network device 104. Signal 140 indicates that network device 140 is having difficulty decoding control channel 114, that control channel 114 is degraded, or that network device 104 is unable to receive control channel 114. For example, in certain embodiments where communication network 100 operates at least partially according to a DOCSIS communication protocol, signal 140 includes a PLC failure event-type code. One example of a PLC failure event-type code is event code 21—“PLC failure,” as defined in DOCSIS 3.1 MAC and Upper Layer Protocol Interface Specification, version CM-SP-MULPIv3.1-I18-190422, Section 10.6.4.1.2, table 101, which is incorporated herein by reference. In some other embodiments, signal 140 is a “dying gasp” signal, e.g. a signal transmitted by network device 104 before the network device reboots due to loss of control information 118.

In a block 504 of method 500, control subsystem 106 causes control channel 114 to move from a first location in radio-frequency spectrum to a second location in radio-frequency spectrum, in response to receiving signal 140. For example, in an embodiment, control subsystem 106 generates a relocate control channel command 136 in response to receiving signal 140, and network hub 102 causes control channel 114 to move from first location 302 to second location 304, as illustrated in FIG. 3. As discussed above, in some embodiments, processing subsystem 120 executes instructions 124 to determine the second location in radio-frequency spectrum, e.g. location 304 of FIG. 3, such that the second location is relatively-free, or completely-free, of radio-frequency that is in-use at communication network 100, such as by using database 126.

In some cases, there may not be an available location in radio-frequency spectrum that is free from interference. Therefore, in some embodiments, control subsystem 106 is configured to leave a location of control channel 114 in radio-frequency spectrum unchanged if control subsystem 106 is unable to find a suitable alternate location for the control channel. In such embodiments, control subsystem 106 is optionally configured to signal an external device or system that control subsystem 106 is unable to relocate control channel 114 in radio-frequency spectrum to mitigate interference.

Relocating control channel 114 in radio-frequency spectrum may interrupt operation of some embodiments of network device 104, such as by causing network device 104 to reboot. Accordingly, in some embodiments, a notification signal 142 is provided to network device 104 before control subsystem 106 causes control channel 114 to move from the first location in radio-frequency spectrum to the second location in radio-frequency spectrum. Notification signal 142 indicates to network device 104 an upcoming change in the location of control channel 114 from the first location in radio-frequency spectrum to the second location in radio-frequency spectrum. In some embodiments, notification signal 142 further identifies the second location in radio-frequency spectrum, e.g. a center frequency of the second location, a frequency span of the second location, and/or starting and ending frequencies of the second location. In particular embodiments, network device 104 is configured to prepare for a change in location of control channel 114 in radio-frequency spectrum, in response to receiving notification signal 142. For example, in some embodiments, network device 104 will change operating modes in response to receipt of notification signal 142, to prevent network device 104 from rebooting in response to relocation of control channel 114 in radio-frequency spectrum. In certain embodiments where communication network 100 operates at least partially according to a DOCSIS communication protocol, notification signal 142 is included in a PLC. Including notification signal 142 in a PLC may help achieve reliable transmission of notification signal 142 because a PLC is typically transmitted using a robust modulation scheme, as discussed above.

In some embodiments, network hub 102 generates notification signal 142, such as in response to receipt of relocate control channel command 136 from control subsystem 106, and network hub 102 transmits notification signal 142 to network device 104 via downlink communication channel 110. In some other embodiments, control subsystem 106 generates notification signal 142, and network hub 102 forwards notification signal 142 to network device 104.

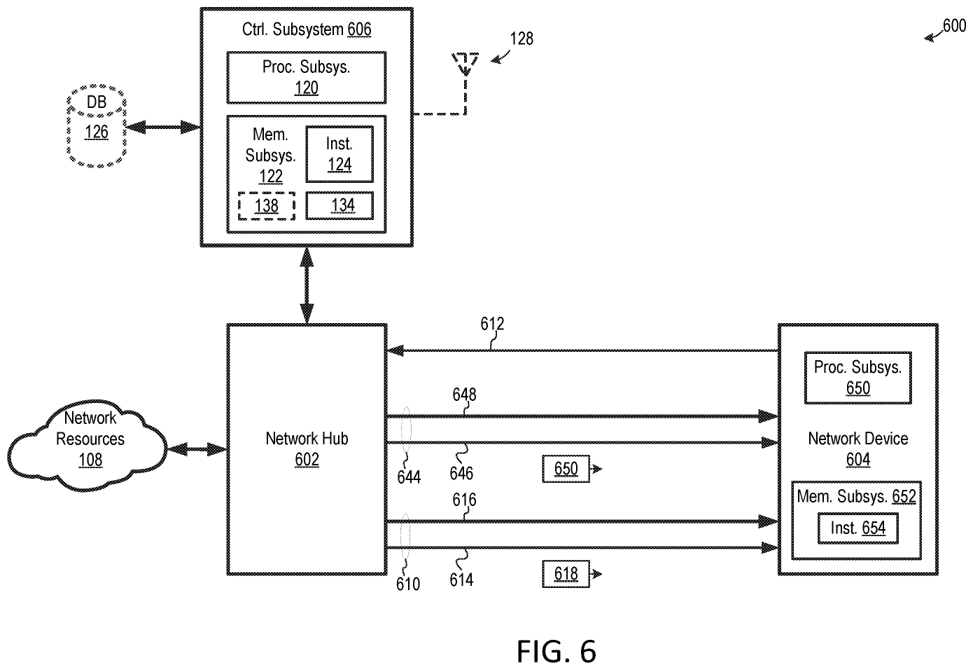

Applicant has additionally determined that multiple control channels can be used to prevent interruption of a network device in response to relocation of one control channel in radio-frequency spectrum. For example, FIG. 6 is a schematic diagram illustrating a communication network 600 configured to automatically manage a control channel, where the communication network includes two control channels. Communication network 600 includes a network hub 602, a network device 604, and a control subsystem 606, which are embodiments of network hub 102, network device 104, and control subsystem 106, respectively. Although FIG. 6 only includes a single network device 604 for illustrative simplicity, communication network 600 may (and often will) include a plurality of network devices.

Network device 604 is communicatively coupled to network hub 602 via a first downlink communication channel 610, a second downlink communication channel 644, and an uplink communication channel 612. Network device 604 may be communicatively coupled to network hub 602 via additional communication channels without departing from the scope hereof. In some embodiments, first downlink communication channel 610, second downlink communication channel 644, and uplink communication channel 612 include optical cable, electrical cable (e.g. coaxial electrical cable and/or twisted-pair electrical cable), and/or a wireless communication link. In certain embodiments, two or more of first downlink communication channel 610, second downlink communication channel 644, and uplink communication channel 612, share one or more common communication mediums.

First downlink communication channel 610 includes a first control channel 614 and a first data channel 616, and second downlink communication channel 644 includes a second control channel 616 and a second data channel 648. In some embodiments, first and second downlink communication channels 610 and 644 are each an OFDM communication channel. First control channel 614 carries first control information 618 to network device 604, and second control channel 646 carries second control information 650 to network device 604. Some possible examples of first and second control information 618 and 650 include, but are not limited to, modulation scheme information, error-correction information, communication channel bandwidth information, and/or communication channel frequency information. In some embodiments where communication network 600 operates at least partially according to a DOCSIS communication protocol, first control channel 614 and second control channel 646 each includes a respective PLC. In certain embodiments where communication system 600 operates according to a 4G or 5G wireless communication protocol, first control channel 614 and second control channel 646 each includes a respective a PBCH. First and second data channels 616 and 648 each carry data from network hub 602 to network device 604.

In some embodiments where communication network 600 operates at least partially according to a DOCSIS communication protocol, first downlink communication channel 610 is a DOCSIS 3.0 communication channel, and second downlink communication channel 644 is a DOCSIS 3.1 communication channel, or vice-versa. A DOCSIS 3.0 communication channel may be more robust than a DOCSIS 3.1 communication channel, and a DOCSIS 3.0 communication channel may therefore be able to provide control information to network device 604 in situations where a DOCSIS 3.1 communication channel is unable to provide control information to network device 604. In some other embodiments where communication network 600 operates at least partially according to a DOCSIS communication protocol, first and second downlink communication channels are each DOCSIS 3.0 communication channels or DOCSIS 3.1 communication channels. In some embodiments, first control channel 614 is a primary control channel, and second control channel 646 is a secondary control channel, or vice-versa. For example, the primary control channel may be a DOCSIS 3.1 control channel, and the secondary control channel may be a DOCSIS 3.0 control channel, or vice versa. In these embodiments, network device 604 is optionally configured to automatically switch from the primary control channel to the secondary control channel in response to network device 604 failing to receive the primary control channel, or in response to network device 604 being unable to decode the primary control channel.

Uplink communication channel 612 carries information from network device 604 to network hub 602. In some embodiments, uplink communication channel 612 includes a control channel (not shown) and a data channel (not shown).

Communication network 600 is configured to operate similarly to communication network of FIG. 1. For example, control subsystem 606 is configured to move first control channel 614 from a first location in radio-frequency spectrum to a second location in radio-frequency spectrum, such as by executing method 200 or method 500 of FIGS. 2 and 5, respectively. Similarly, control subsystem 606 is configured to move second control channel 646 from a first location in radio-frequency spectrum to a second location in radio-frequency spectrum, such as by executing method 200 or method 500 of FIGS. 2 and 5, respectively. However, presence of two control channels, i.e. first and second control channels 614 and 646, helps prevent interruption of network device 604 when one of the control channels is relocated in radio-frequency spectrum. For example, in some embodiments, network device 604 is configured such that it will remain operational as-long-as one of first control information 618 or second control information 650 is available, thereby preventing relocation of one of first control channel 614 or second control channel 646 in radio-frequency spectrum from interrupting network device 604's operation.

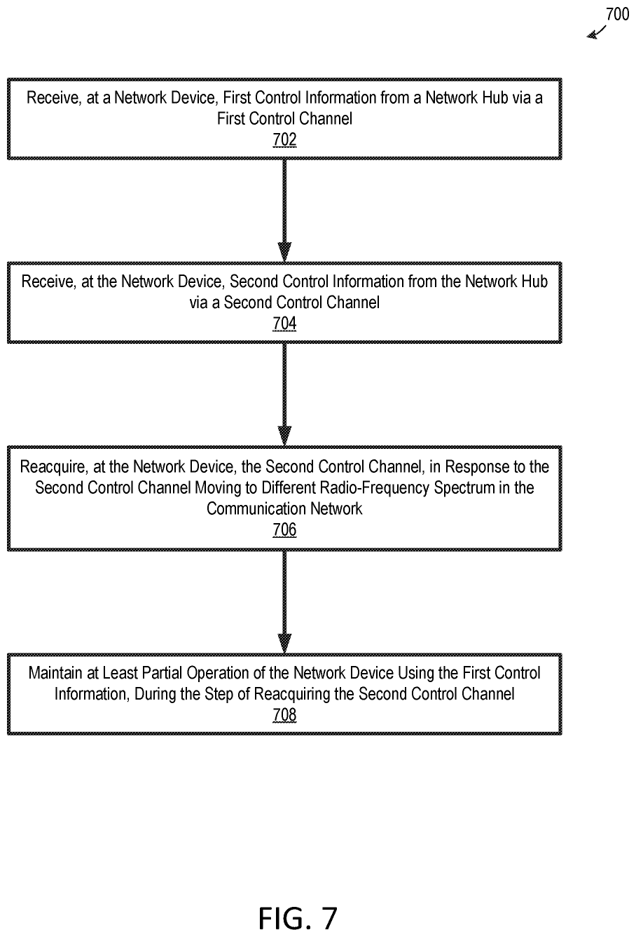

For instance, in certain embodiments, network device 604 includes a processing subsystem 650 and a memory subsystem 652, and processing subsystem 652 is configured to execute instructions 654 stored in memory subsystem 652 to execute a method 700 of FIG. 7 for automatically managing a control channel in a communication network. In a block 702 of method 700, network device 604 receives first control information 618 from network hub 602 via first control channel 614. In a block 704 of method 700, network device 604 receives second control information 650 from network hub 602 via second control channel 646. In a block 706 of method 700, network device 604 reacquires second control channel 646, in response to second control channel 646 moving to different radio-frequency spectrum in communication network 600, in response to a command from control subsystem 606. In a block 708 of method 700, network device 604 maintains at least partial operation using first control information 618, while reacquiring the second control channel 646. Accordingly, presence of two control channels in communication network 600 promotes network reliable operation while relocating a control channel in radio-frequency spectrum. One of more additional control channels could be added to further promote reliable operation, e.g. a network device receiving respective control information from three control channels may remain operational if up to two of the control channels are relocated in radio-frequency spectrum.

It may be desirable to implement the techniques disclosed herein a communication network including a legacy network hub that is incapable of relocating a control channel in radio-frequency spectrum. Accordingly, Applicant has developed control channel translation devices that can be used to relocate a control channel in radio-frequency spectrum.

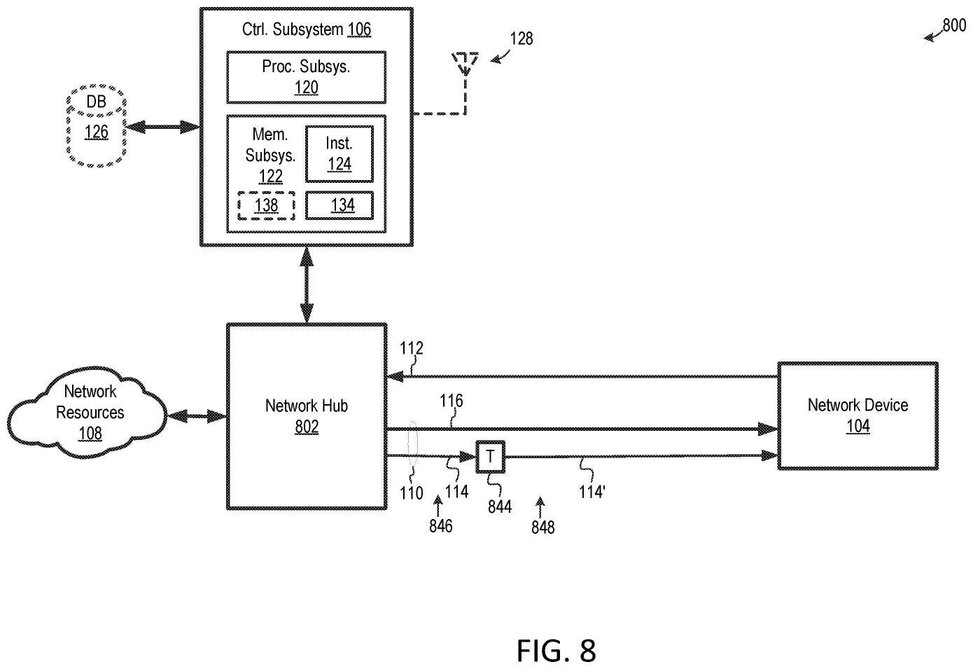

For example, FIG. 8 is a schematic diagram illustrating a communication network 800 configured to automatically manage a control channel. Communication network 800 is similar to communication network 100 of FIG. 1 except that (a) network hub 100 is replaced with a network hub 802 that is incapable of relocating a control channel in radio-frequency spectrum and (b) communication network 800 further includes a control channel translation device 844. Control channel translation device 844 is logically connected in control channel 114 between network hub 802 and network device 104. In some embodiments, control channel translation device 844 includes a processing subsystem (not shown) and a memory subsystem (not shown), and the processing subsystem is configured to execute instructions stored in the memory subsystem to perform the functions of control channel translation device 844. In some other embodiments, control channel translation device 844 is virtualized, such as by software or firmware running on another element of communication network 800. Control channel translation device 844 is configured to relocate a control channel in radio-frequency spectrum without assistance from network hub 802. In particular, control channel translation device 844 is configured to (a) receive control channel 114 from network hub 802 and (b) and generate a new control channel 114′ for transmission to network device 104. Control channel 114′ is identical to control channel 114 except that control channel 114′ is at a different location in radio frequency spectrum than control channel 114.

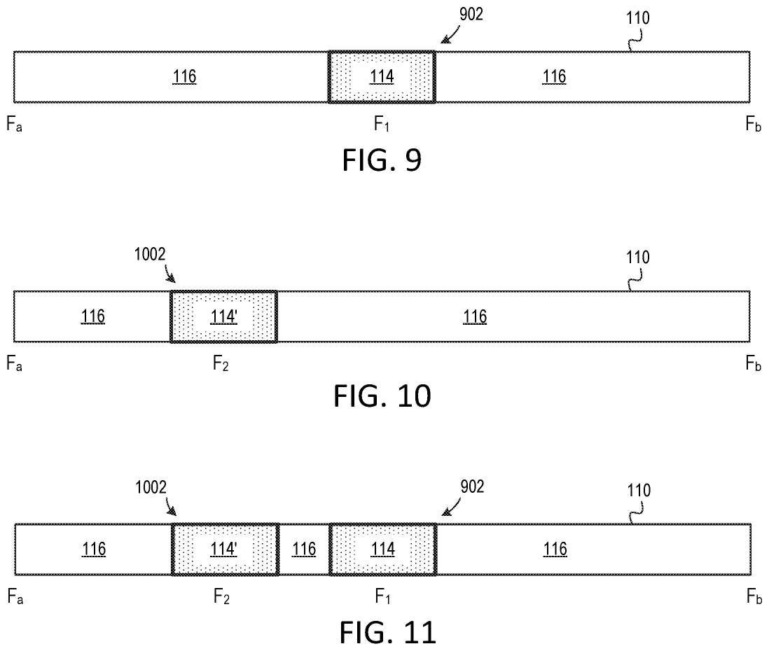

For example, FIGS. 9 and 10 are schematic diagrams of downlink communication channel 110 which collectively illustrate one operating example of control channel translation device 844. FIG. 9 schematically illustrates downlink communication channel 110 upstream 846 of control channel translation device 844, where control channel 114 is at a first location 902 in radio-frequency spectrum having a center frequency F₁. FIG. 10 schematically illustrates downlink communication channel 110 downstream 848 of control channel translation device 844, where control channel 114′ is at a second location 1002 in radio-frequency spectrum having a center frequency F₂. Thus, control channel translation device 844 effectively translates the control channel of downlink communication channel 110 from a first location 902 to a second location 1002.

In some embodiments, control channel translation device 844 is configured to pass control channel 114 along to network device 104, as well as to generate control channel 114′. For example, FIG. 11 schematically illustrates downlink communication channel 110 downstream 848 of control channel translation device 844, in an embodiment where control channel translation device 844 is configured to (a) pass control channel 114 along to network device 104, and (b) generate control channel 114′ at second location 1002 in radio-frequency spectrum.

In some embodiments, control channel translation device 844 receives a command to relocate control channel 114, e.g. an instance of relocate control channel command 136, from control subsystem 106 via network hub 802. In some other embodiments, control channel translation device 844 receives a command to relocate control channel 114 in another manner, e.g. directly from control subsystem 106. In an alternate embodiment of communication network 800, control subsystem 106 is communicatively coupled to control channel translation device 844 instead of to network hub 802. Additionally, in another alternate embodiment, control subsystem 106 is integrated in control channel translation device 844.

In some embodiments, control subsystem 106 is configured to change a temporal aspect of control channel 114, in addition to, or instead of, relocating control channel 114 in radio-frequency spectrum, to mitigate control channel interference. For example, referring to FIG. 1 again, in certain embodiments, processing subsystem 120 is configured to execute instructions 124 to cause control information 118 to be transmitted to network device 104 at times when interfering signal source 132 is not transmitting signals, or at times when interfering signal source 132 is transmitting signals at relatively low power, to help minimize control channel 114 interference. For instance, in some embodiments, control subsystem 106 is configured to (a) determine that interfering signals at control channel 114 have a constant duty cycle and (b) in response, cause network hub 102 to transmit control information 118 during minimum amplitude (e.g. logic-zero) portions of the interfering signals. One possible example of interfering signals having a constant duty cycle are unlicensed long-term evolution (LTE-U) signals. In some embodiments, network hub 102, instead of, or in additional to, control subsystem 106, causes transmission of control information 118 at times when interfering signal source 132 is not transmitting signals, or when interfering signal source 132 is transmitting signals at relatively low power.

Some communication networks may experience control channel interference in only a subset of the network. For example, one branch of a communication network near a wireless base station may experience control channel interference, while a branch of the network distant from the wireless base station may not experience control channel interference. Accordingly, some embodiments of communication network 100 are configured to automatically relocate a control channel in radio-frequency spectrum in only a subset of the network that is experiencing control channel interference.

For example, FIG. 12 is a schematic diagram illustrating a communication network 1200 configured to automatically manage a control channel, where communication channel location in radio-frequency spectrum may be controlled on a branch-by-branch basis. Communication network 1200 includes a network hub 1202, a network device 1204, a network device 1244, and a control subsystem 1206. Network hub 1202 and control subsystem 1206 are embodiments of network hub 102 and control subsystem 106, respectively. Each of network device 1204 and network device 1244 is an embodiment of network device 104. Communication network 1200 includes two branches, i.e. a branch 1246 and a branch 1248. Network device 1204 is part of branch 1246, and network device 1244 is part of branch 1248. Although FIG. 12 illustrates only a single network device on each branch 1246 and 1248 for illustrative simplicity, communication network 1200 may (and often will) include a plurality of network devices on each branch. Additionally, communication network 1200 may include additional branches without departing from the scope hereof.

Network hub 1202 includes a central element 1250 and remote elements 1252 and 1254. Remote element 1252 and remote element 1254 are each communicatively coupled to central element 1250 via communication media 1256. Communication media 1256 includes, for example, optical cable, electrical cable, and/or wireless communication links. Remote element 1252 serves branch 1246, and remote element 1254 serves branch 1248. Functionality of network hub 1202 is divided between central element 1250 and remote elements 1252, 1254. For example, in some embodiments, central element 1250 performs control of network hub 1202, and remote elements 1252 and 1254 interface respective branches 1246 and 1248 with network hub 1202. In certain embodiments, central element 1250 is a CMTS, and each remote node 1252 and 1254 is a fiber node. In this embodiment, a fiber node interfaces one or more optical cables with one or more electrical cables.

Remote nodes 1252 and 1254 could be commonly packaged without departing from the scope hereof. For example, in some embodiments, remote nodes 1252 and 1254 are collectively embodied by 2×2 fiber node or a 4×4 fiber node. A 2×2 fiber node can support two independent uplink channel groups and two independent downlink channel groups, and a 4×4 fiber node can support four independent uplink channel groups and four independent downlink channel groups. In certain other embodiments, central element 1250 is a wireless communication network core and each remote element 1252 and 1254 is a wireless base station.

Network device 1204 is communicatively coupled to remote element 1252 via a downlink communication channel 1210 and an uplink communication channel 1212, and network device 1244 is communicatively coupled to remote element 1254 via a downlink communication channel 1258 and an uplink communication channel 1260. Each of network devices 1204 and 1244 may be communicatively coupled to remote elements 1252 and 1254, respectively, via additional communication channels without departing from the scope hereof. In some embodiments, downlink communication channel 1210, downlink communication channel 1258, uplink communication channel 1212, and uplink communication channel 1260 include an optical cable, an electrical cable (e.g. coaxial electrical cable and/or twisted-pair electrical cable), and/or a wireless communication link. In certain embodiments, downlink communication channel 1210 and uplink communication channel 1212 share one or more common communication mediums, such as a common electrical cable. Similarly, in some embodiments, downlink communication channel 1258 and uplink communication channel 1260 share one or more common communication mediums, such as a common electrical cable.

Downlink communication channel 1210 includes a control channel 1214 and a data channel 1216, and downlink communication channel 1258 includes a control channel 1262 and a data channel 1264. In some embodiments, downlink communication channels 1210 and 1258 are each an OFDM communication channel. Control channel 1214 carries control information 1218 to network device 1204, and control channel 1262 carries control information 1266 to network device 1244. Some possible examples of control information 1218 and 1266 include, but are not limited to, modulation scheme information, error-correction information, communication channel bandwidth information, and/or communication channel frequency information. In some embodiments where communication network 1200 operates at least partially according to a DOCSIS communication protocol, control channel 1214 and control channel 1262 each includes a respective PLC. In certain embodiments where communication system 1200 operates according to a 4G or 5G wireless communication protocol, control channel 1214 and control channel 1262 each includes a respective a PBCH. Data channels 1216 and 1264 each carry data from network hub 1202 to network devices 1204 and 1244, respectively.

Uplink communication channel 1212 carries information from network device 1204 to network hub 1202, and uplink communication channel 1260 carries information from network device 1244 to network hub 1202. In some embodiments, uplink communication channels 1212 and 1260 each include a control channel (not shown) and a data channel (not shown).

Communication network 1200 is configured to operate similarly to communication network 100 of FIG. 1, such as by executing methods similar to method 200 (FIG. 2) or method 500 (FIG. 5). However, communication network 1200 is configured to independently relocate a control channel in radio-frequency spectrum on a branch-by-branch basis. Accordingly, control subsystem 1206 is capable of causing relocation of control channel 1214 in radio-frequency spectrum without affecting location of control channel 1262 in radio-frequency spectrum. Similarly, control subsystem 1206 is capable of causing relocation of control channel 1262 in radio-frequency spectrum without affecting location of control channel 1214 in radio-frequency spectrum. Such ability of control subsystem 1206 to relocate a control channel in radio-frequency spectrum on a branch-by-branch basis helps minimize disruption of communication network 1200 when addressing control channel interference.

For example, consider a scenario where an interfering signal source 1232 is near branch 1248 but is distant from branch 1246. In this example scenario, interfering signal source 1232 interferes with control channel 1262 of branch 1248, but interfering signal source 1232 does not interfere with control channel 1214 of branch 1246. Consequently, control subsystem 1206 causes network hub 1202 to move control channel 1262 from a first location in radio-frequency spectrum to a second location in radio-frequency spectrum, but control subsystem 1206 does not cause control channel 1214 to be moved in radio-frequency spectrum. Accordingly, control subsystem 1206 mitigates control channel interference in branch 1248 without affecting control channel operation in branch 1246.

Furthermore, in some embodiments, control subsystem 1206 is additionally configured to proactively prevent interference with control channels 1214 and 1262 by selecting initial locations of control channels 1214 and 1262 in radio-frequency spectrum on a branch-by-branch basis in a manner which reduces, or eliminates, frequency overlap of the control channels with possibly-interfering radio-frequency spectrum. For example, in some embodiments, database 126 identifies possibly-interfering radio-frequency spectrum on a branch-by-branch basis. For instance, in one example embodiment, database 126 identifies (a) radio-frequency spectrum X which will possibly interfere with control channel 1214 and (b) radio-frequency spectrum Y which will possibly interfere with control channel 1262, where X is different from Y. In this embodiment, processing subsystem 120 executes instructions 124 such that (a) control channel 1214 is initially positioned in radio-frequency spectrum so that it does not overlap radio-frequency spectrum X and (b) control channel 1262 is positioned in radio-frequency spectrum so that it does not overlap radio-frequency spectrum Y.

In some embodiments including additional branches, two or more branches share a control channel, such that control channel location in radio-frequency spectrum cannot be independently relocated for each branch. For example, in one alternate embodiment (not shown) of communication network 1200, each of remote element 1252 and remote element 1254 is a 2×2 fiber node supporting four respective branches, such that communication network 1200 has a total of eight branches. In this embodiment, remote elements 1252 and 1254 can each support two control channels, and therefore, at least some branches need to share a control channel. Therefore, control subsystem 1206 and network hub 1202 cannot independently relocate a control channel in radio-frequency spectrum for each of the eight branches.

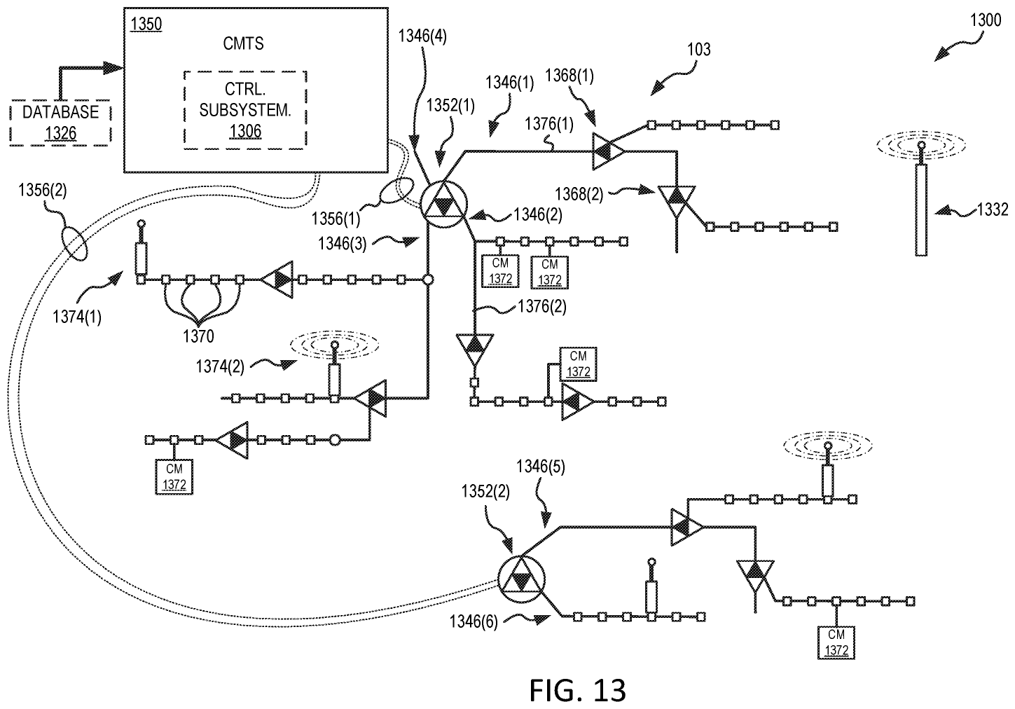

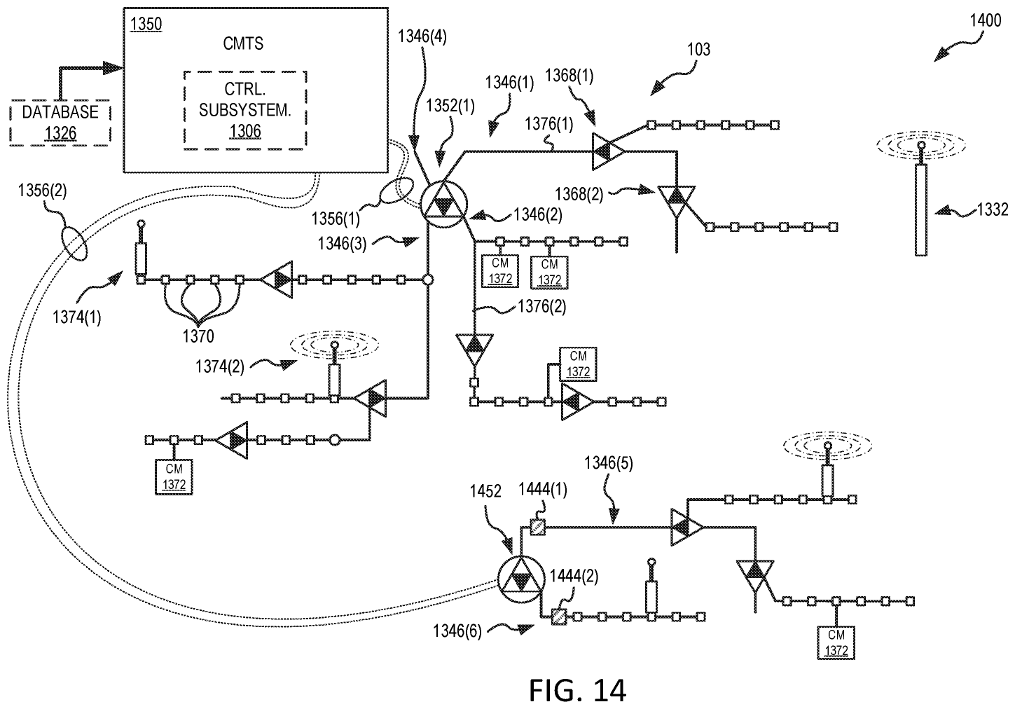

Discussed below with respect to FIGS. 13-15 are several additional examples of embodiments of communication network 100, and in these embodiments, the communication network is a cable communication system with multiple branches. It should be appreciated, however, that communication network 100 is not limited to cable communication networks or the embodiments of FIGS. 13-15. Instead, communication network 100 could be another type of communication network, such as a wireless communication network, as discussed above. Additionally, the communication networks of FIGS. 13 and 14 could be modified to be different types of communication networks without departing from the scope hereof.

FIG. 13 is a schematic diagram illustrating a cable communication network 1300 configured to automatically manage control channels. Communication network 1300 includes a CMTS 1350, a control subsystem 1306, a plurality of fiber nodes 1352, a plurality of amplifiers 1368, a plurality of taps 1370, a plurality of cable modems (CMs) 1372, and a plurality of small cell wireless base stations 1374. Only several instances amplifiers 1368, taps 1370, and wireless base stations 1374 are labeled in FIG. 13 to promote illustrative clarity. In this document, specific instances of an item may be referred to by use of a numeral in parentheses (e.g., fiber node 1352(1)) while numerals without parentheses refer to any such item (e.g., fiber nodes 1352).

Each fiber node 1352 is communicatively coupled to CMTS 1350 via a fiber optic cable 1356, and fiber optic cables 1356 carry signals between fiber nodes 1352 and CMTS 1350. Each fiber node 1352 supports one or more branches 1346. For example, fiber node 1352(1) supports branches 1346(1)-1346(4), and fiber node 1352(2) supports branches 1346(5)-1346(6). Each branch 1346 includes coaxial electrical cable 1376 to carry radio-frequency electrical signals, and some branches 1346 include one or more amplifiers 1368 to amplify the radio-frequency electrical signals. Only two instances of coaxial electrical cable 1376 are labeled in FIG. 13 to promote illustrative clarity. A plurality of taps 1370 are connected to coaxial electrical cable 1376 to provide customer access to communication network 1300, and CMs 1372 and/or wireless base stations 1374 are connected to at least some instances of taps 1370. CMs 1372 and wireless base stations 1374 are each an embodiment of network device 104 (FIG. 1). Although FIG. 13 shows many taps 1370 without respective network devices connected thereto, it is anticipated that the majority of taps 1370 in many embodiments of communication network 1300 will have a network device connected thereto.

CMTS 1350 and fiber nodes 1352 collectively form an embodiment of network hub 102 (FIG. 1). Communication network 1300 optionally further includes a database 1326 communicatively coupled to CMTS 1350, where database 1326 is an embodiment of database 126. Although control subsystem 1306 is illustrated as being part of CMTS 1350, control subsystem 1306 could alternately be separate from CMTS. Additionally, an interfering signal source 1332 is not necessarily part of communication network 1300.

Communication network 1300 is configured to operate similarly to communication network of FIG. 1. For example, in some embodiments, control subsystem 1306 is configured to move a control channel from a first location in radio-frequency spectrum to a second location in radio-frequency spectrum, such as by executing method 200 or method 500 of FIGS. 2 and 5, respectively, or by executing method 1500, discussed below. In some embodiments, fiber nodes 1352 are 4×4 fiber nodes, and communication network 1300 is accordingly configured to independently relocate a control channel in radio-frequency spectrum on a branch-by-branch basis. For example, in one embodiment where fiber node 1352(1) is a 4×4 fiber node, control subsystem 1306 and CMTS 1350 are collectively configured to move a control channel in branch 1346(1) from a first location in radio-frequency spectrum to a second location in radio-frequency spectrum, such as to mitigate interference from interfering signal source 1332, without affect control channels of branches 1346(2)-1346(4).

In some other embodiments, fiber nodes 1352 are 2×2 fiber nodes, and communication network 1300 is accordingly configured to such that at most two different control channel locations in radio-frequency spectrum can be supported by a given fiber node 1352. Accordingly, in these embodiments, it is not feasible to independently relocate a control channel in radio-frequency spectrum for three or more branches served by a common fiber node 1352. For example, a control channel of branch 1346(1) could be relocated in radio-frequency spectrum independently of a control channel shared by branches 1346(2)-1346(4), but control channels of branches 1346(2)-1346(4) would have to be relocated in radio-frequency spectrum together. As another example, a control channel shared by branches 1346(1) and 1346(2) could be relocated in radio-frequency spectrum independently of a control channel shared by branches 1346(3) and 1346(4), but branches 1346(1) and 1346(2) could not have different respective control channel locations, since branches 1346(1) and 1346(2) share a common control channel, in this example.

FIG. 14 is a schematic diagram illustrating a cable communication network 1400 configured to automatically manage control channels. Cable communication network 1400 is similar to communication network 1300 of FIG. 13, except that (a) fiber node 1352(2) is replaced with fiber node 1452 and (b) each of branches 1346(5) and 1346(6) includes a respective control channel translation device 1444. Fiber node 1452 is not capable of relocating control channels in radio-frequency spectrum, and each of branches 1346(5) and 1346(6) therefore includes a respective channel translation device 1444 to enable the branch's control channel to be relocated in radio-frequency spectrum. Each channel translation device 1444 is an embodiment of control channel translation device 844 of FIG. 8. Control channel translation devices 1444 could be located at different locations in their respective branches without departing from the scope hereof.

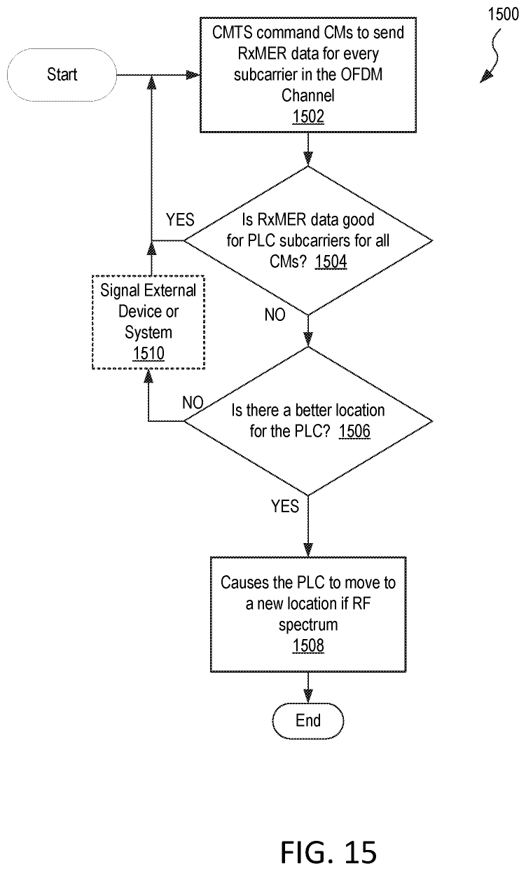

FIG. 15 is a flow chart illustrating a method 1500 for automatically managing a control channel in a communication network. Method 1500 is another possible operating method for communication networks 1400 and 1500 of FIGS. 14 and 15, respectively. In a block 1502 of method 1500, CMTS 1350 commands each CM 1372 to send RxMER data each subcarrier of every OFDM communication channel received by the CM. In a decision block 1504 of method 1500, control subsystem 1306 determines whether the RxMER data for every subcarrier associated with a control channel (e.g. PLC) is good, e.g. not exceeding a maximum allowable value. If the result of decision block 1504 is yes, method 1500 returns to block 1502; if the result of decision block 1504 is no, method proceeds to a decision block 1506.

In decision block 1506, control subsystem 1306 determines whether there is a better location for the control channel (e.g. PLC) in radio-frequency spectrum. In one example of decision block 1506, control subsystem 1306 checks database 1326 for an alternate location in radio-frequency spectrum that is at least substantially free of interference, to find an alternate location that is a better location for the control channel. If the result of decision block 1506 is no, method 1500 returns to block 1502, or method 1500 proceeds to an optional block 1510 before returning to block 1502. In optional block 1510, control subsystem 1306 signals an external device or system that control subsystem 1306 is unable to relocate a control channel in radio-frequency spectrum to mitigate interference.

If the result of decision block 1506 is yes, method 1500 proceeds to a block 1508. In block 1508, control subsystem 1306 causes the control channel (e.g. PLC) to move to a new location in radio-frequency spectrum. In one example of block 1508, control subsystem 1306 generates a relocate control channel command to cause fiber node 1352(1) to move a control channel for branch 1346(3) from a first location in radio-frequency spectrum to a second location in radio-frequency spectrum. In another example of block 1508, control subsystem 1306 generates a relocate control channel command to cause fiber node 1352(1) to move a control channel shared by each of branches 1346(3) and 1346(4) from a first location in radio-frequency spectrum to a second location in radio-frequency spectrum. In yet another example of block 1508, control subsystem 1306 generates a relocate control channel command to cause control channel translation device 1444 to move a control channel for branch 1346(6) from a first location in radio-frequency spectrum to a second location in radio-frequency spectrum.

### Combinations of Features

Features described above may be combined in various ways without departing from the scope hereof. The following examples illustrate some possible combinations:

(A1) A method for managing a control channel in a communication network may include (1) receiving, at a control subsystem, first status information from a network device, (2) comparing, at the control subsystem, the first status information to a first threshold condition, and (3) in response to the first status information meeting the first threshold condition, causing a first control channel in the communication network to move from a first location in radio-frequency spectrum to a second location in radio-frequency spectrum.

(A2) The method denoted as (A1) may further include determining the second location in radio-frequency spectrum at least partially based on one or more identified radio-frequency spectrum in use at the communication network.

(A3) In any of the methods denoted as (A1) and (A2), the first status information may include modulation error information of one or more components of the first control channel.

(A4) Any of the methods denoted as (A1) through (A3) may further include providing a notification signal to the network device before causing the first control channel to move from the first location in radio-frequency spectrum to the second location in radio-frequency spectrum, the notification signal indicating a change in a location of the first control channel from the first location to the second location.

(A5) In any of the methods denoted as (A1) through (A4), the first control channel may be one of a control channel of an orthogonal frequency-division multiplexing (OFDM) communication channel and a control channel of an orthogonal frequency-division multiple access (OFDMA) communication channel.

(A6) In any of the methods denoted as (A1) through (A5), the first control channel may include a Data Over Cable Services Interface Specification (DOCSIS) Physical Link Channel (PLC).

(A7) In any of the methods denoted as (A1) through (A5), the communication network may operate at least partially according to a wireless communication protocol.

(A8) In the method denoted as (A7), the first control channel may include a Physical Broadcast Channel (PBCH).

(A9) In any of the methods denoted as (A1) through (A8), the second location in radio frequency spectrum may be lower in frequency than the first location in radio-frequency spectrum.

(B1) A method for managing a control channel in a communication network may include (1) receiving, at a control subsystem, a first signal from a network device, and (2) in response to receiving the first signal, causing a first control channel in the communication network to move from a first location in radio-frequency spectrum to a second location in radio-frequency spectrum.

(B2) The method denoted as (B1) may further include determining the second location in radio-frequency spectrum at least partially based on a database of radio-frequency spectrum in use at the communication network.

(B3) Any of the methods denoted as (B1) and (B2) may further include providing a notification signal to the network device before causing the first control channel to move from the first location in radio-frequency spectrum to the second location in radio-frequency spectrum, the notification signal indicating a change in a location of the first control channel from the first location to the second location.

(B4) In any of the methods denoted as (B1) through (B3), the first control channel may be one of a control channel of an orthogonal frequency-division multiplexing (OFDM) communication channel and a control channel of an orthogonal frequency-division multiple access (OFDMA) communication channel.

(B5) In any of the methods denoted as (B1) through (B4), the communication network may operate at least partially according to a Data Over Cable Services Interface Specification (DOCSIS) communication protocol.

(B6) In the method denoted as (B5), the first control channel may include a DOCSIS Physical Link Channel (PLC).

(B7) In any of the methods denoted as (B1) through (B6), the first signal may include a PLC failure event-type code.

(B8) In any of the methods denoted as (B1) through (B4), the communication network may operate at least partially according to a wireless communication protocol.

(B9) In the method denoted as (B8), the first control channel may include a Physical Broadcast Channel (PBCH).

(C1) A method for managing a control channel in a communication network may include (1) receiving, at a network device, first control information from a network hub via a first control channel, (2) receiving, at the network device, second control information from the network hub via a second control channel, (3) reacquiring, at the network device, the second control channel, in response to the second control channel moving to different radio-frequency spectrum in the communication network, and (4) maintaining at least partial operation of the network device using the first control information, during the step of reacquiring the second control channel.

(C2) In the method denoted as (C1), the first and second control channels may be control channels of one of (a) orthogonal frequency-division multiplexing (OFDM) communication channels and (b) orthogonal frequency-division multiple access (OFDMA) communication channels.

(C3) In any of the methods denoted as (C1) and (C2), the communication network may operate at least partially according to a Data Over Cable Services Interface Specification (DOCSIS) communication protocol.

(C4) In the method denoted as (C3) each of the first control channel and the second control channel may include a respective DOCSIS Physical Link Channel (PLC).

(C5) In any of the methods denoted as (C3) and (C4), the first control channel may be associated with a DOCSIS 3.0 communication channel, and the second control channel may be associated with a DOCSIS 3.1 communication channel.

(C6) In any of the methods denoted as (C3) and (C4), the first and second control channels may be associated with respective DOCSIS 3.1 communication channels.

Changes may be made in the above methods, devices, and systems without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present method and system, which, as a matter of language, might be said to fall therebetween.

What is claimed is:

1. A method for managing a control channel in a communication network, comprising:
receiving, at a control subsystem, first status information from a network device;
comparing, at the control subsystem, the first status information to a first threshold condition; and
in response to the first status information meeting the first threshold condition, causing a first control channel in the communication network to move from a first location in radio-frequency spectrum to a second location in radio-frequency spectrum.

2. The method of claim 1, further comprising determining the second location in radio-frequency spectrum at least partially based on one or more identified radio-frequency spectrum in use at the communication network.

3. The method of claim 1, wherein the first status information comprises modulation error information of one or more components of the first control channel.

4. The method of claim 1, further comprising providing a notification signal to the network device before causing the first control channel to move from the first location in radio-frequency spectrum to the second location in radio-frequency spectrum, the notification signal indicating a change in a location of the first control channel from the first location to the second location.

5. The method of claim 1, wherein the first control channel is one of a control channel of an orthogonal frequency-division multiplexing (OFDM) communication channel and a control channel of an orthogonal frequency-division multiple access (OFDMA) communication channel.

6. The method of claim 1, wherein the first control channel comprises a Data Over Cable Services Interface Specification (DOCSIS) Physical Link Channel (PLC).

7. The method of claim 1, wherein the communication network operates at least partially according to a wireless communication protocol.

8. The method of claim 1, wherein the second location in radio frequency spectrum is lower in frequency than the first location in radio-frequency spectrum.

9. A method for managing a control channel in a communication network, comprising:
receiving, at a control subsystem, a first signal from a network device; and
in response to receiving the first signal, causing a first control channel in the communication network to move from a first location in radio-frequency spectrum to a second location in radio-frequency spectrum.

10. The method of claim 9, further comprising determining the second location in radio-frequency spectrum at least partially based on a database of radio-frequency spectrum in use at the communication network.

11. The method of claim 9, further comprising providing a notification signal to the network device before causing the first control channel to move from the first location in radio-frequency spectrum to the second location in radio-frequency spectrum, the notification signal indicating a change in a location of the first control channel from the first location to the second location.

12. The method of claim 9, wherein the first control channel is one of a control channel of an orthogonal frequency-division multiplexing (OFDM) communication channel and a control channel of an orthogonal frequency-division multiple access (OFDMA) communication channel.

13. The method of claim 9, wherein the communication network operates at least partially according to a Data Over Cable Services Interface Specification (DOCSIS) communication protocol.

14. The method of claim 9, wherein the first signal comprises a PLC failure event-type code.

15. The method of claim 9, wherein the communication network operates at least partially according to a wireless communication protocol.

16. A method for managing a control channel in a communication network, comprising:
receiving, at a network device, first control information from a network hub via a first control channel;
receiving, at the network device, second control information from the network hub via a second control channel;
reacquiring, at the network device, the second control channel, in response to the second control channel moving to different radio-frequency spectrum in the communication network; and
maintaining at least partial operation of the network device using the first control information, during the step of reacquiring the second control channel.

17. The method of claim 16, wherein the first and second control channels are control channels of one of (a) orthogonal frequency-division multiplexing (OFDM) communication channels and (b) orthogonal frequency-division multiple access (OFDMA) communication channels.

18. The method of claim 16, wherein:
the communication network operates at least partially according to a Data Over Cable Services Interface Specification (DOCSIS) communication protocol; and
each of the first control channel and the second control channel comprises a respective DOCSIS Physical Link Channel (PLC).

19. The method of claim 18, wherein:
the first control channel is associated with a DOCSIS 3.0 communication channel; and
the second control channel is associated with a DOCSIS 3.1 communication channel.

20. The method of claim 18, wherein the first and second control channels are associated with respective DOCSIS 3.1 communication channels.
